(19) United States
(12) Patent Application Publication
(10) Pub. No.: US 2003/0023624 A1
(43) Pub. Date: Jan. 30, 2003

(54) Web browser interest terms

(75) Inventors: Rick Allen Hamilton II, Charlottesville, VA (US); John Steven Langford, Austin, TX (US); Steven Jay Lipton, Flower Mound, TX (US)

Correspondence Address: Robert H. Frantz, P.O. Box 23324, Oklahoma City, OK, 73123-2334, US

(73) Assignee: International Business Machines Corporation, Armonk, NY (US)

(21) Appl. No.: 09/801,593

(22) Filed: Mar. 8, 2001

(51) Int. Cl. G06F 17/30; G06F 17/21

(52) U.S. Cl. 707/501.1

(57) ABSTRACT

A web browser enhancement determines keywords that are of interest to the web browser user, with the interest terms thereafter being available to other programs for use in assisting the web browser user in finding web content of interest to the user. A master list of interest terms is presented to a user, either directly with a master checklist, or indirectly through a series of questions. User selections and answers are recorded, and a user interest term list is created and stored for later availability to other browsing programs and plug-ins.

### BACKGROUND OF THE INVENTION

1. Field of the Invention

This invention relates to the arts of web browsers and servers, and especially to the arts of browsing technologies which provide browsing capabilities prioritized and keyed to a user's personal interests.

2. Description of the Related Art

The Internet and the World Wide Web have become critical, integral parts of commercial operations, personal lives, and the education process. At the heart of Internet is Internet browser technology and Internet server technology. An Internet server contains “content” such as documents, image or graphics files, forms, audio clips, etc., all of which is available to systems and browsers which have Internet connectivity.

Web browser or “client” computers may request documents from web addresses, to which appropriate web servers respond by transmitting one or more web documents, image or graphics files, forms, audio clips, etc. The most common protocol for transmission of web documents and contents from servers to browsers is Hyper Text Transmission Protocol (“HTTP”).

FIG. 1 shows the fundamental client-server arrangement of Internet and intranet communications. A client browser computer (1) is provided with Internet access (2) to the World Wide Web (3) through common means such as a dial-up telephone line and modem, cable modem, or local area network (“LAN”). The web browser computer (1) is also provided with appropriate web browsing software, such as Netscape's Navigator or Microsoft's Explorer. A web server computer (5) is likewise provided with Internet access (4) to the World Wide Web (3) using similar means, or higher-bandwidth means such as T1 and T3 data lines, and a web server suite of software. Alternatively, client and servers may be interconnected via an Intranet (6), such as a corporate LAN. These arrangements are well known within the art.

The most common type of Internet content or document is Hyper Text Markup Language (“HTML”) documents, but other formats are equally well known in the art, such as Adobe Portable Document Format (“PDF”). HTML, PDF and other web documents provide “hyperlinks” within the document, which allow a user to select another document or web site to view. Hyperlinks are specially marked text or areas in the document which when selected by the user commands the browser software to retrieve or fetch the indicated document.

Ordinarily, when the user selects a plain hyperlink the current page being displayed in the web browser's graphical user interface (“GUI”) window disappears and the newly received page is displayed. If the parent page is an index, for example the IBM web site www.patents.ibm.com, and the user wishes to visit each descending link (e.g. read the document with tips on how to use the site), then the parent or index page disappears and the new page is displayed (such as the help page).

As the computing capacity of web browser computers increase and the communications bandwidth to the web browser computer increase dramatically, one challenge for organizations who provide Internet web sites and content is to deliver and filter such content in anticipation of these greater processing and throughput speeds.

This is particularly true in the realm of web-based applications, and in the development of better and more efficient ways to move user-pertinent information to the desktop or client.

However, today's web browsers are in general unintelligent software packages. As they currently exist, they require the user to manually search for any articles or documents of interest to him or her, and are often cumbersome in that they frequently require download of many documents before one of germane interest is found.

Search engines provide some level of “intelligence” to the browsing experience, wherein a user may point his unintelligent web browser to a search engine address, enter some keywords for a search, and then review each of the returned documents one at a time by selecting hyperlinks in the search results, or by re-pointing the web browser manually to provided web addresses. However, search engines to not really search the entire Internet, rather they search their own indices of Internet content which has been built by the search engine operator, usually through a process of reviewing manual submissions from other web site operators. Thus, it is common for a user to use several search engines while looking for information on a particular subject, because each search engine will return different results based on their own index content.

To partially address this problem, two other technologies have been developed and are well-known in the art. The first technology is known as a “metasearch engine” which is a search engine of search engines. A metasearch engine does not keep its own index, but rather submits a query to multiple search engines simultaneously, and returns to the user the highest ranked returns from each of the search engines. While this is more useful than manually serially visiting each of the queried search engines, the results are typically less satisfying than would be expected. Commonly, the top few returns on a list of ranked matches to the search keywords are not the most interesting, and so more often than not, a user visits the sites listed towards the middle or end of the return list. The metasearch engine may, though, return the top 5 of listings from 4 search engines, which may filter out the more likely interesting information.

The second attempt at solving this problem is known as web “crawler” engines. These servers periodically contact other servers to “re-index” previously indexed web site content, which tends to keep them more up-to-date and incorporates into their index any newly available information a web site. However, since thousands of new web sites are brought on-line each day, it is practically impossible for a crawler to visit new sites. So, even web crawlers may not provide full coverage of internet content.

Other attempts to provide users with more complete information relevant to their own interests are found in several U.S. and foreign patents. For example, U.S. Pat. No. 5,931,907 discloses a system for accessing information stored in a distributed information database using a “community of intelligent agents”. In this invention, the software agent uses “keyword sets” to locate information of interest to a user, and the “keyword sets” can be extended by use of a thesaurus (see abstract, FIGS. 2-3, and claim 1). This invention, however, appears to require the installation of the intelligent software agents throughout the Internet, and as such, presents complexities and logistical issues not usually solvable by an individual web browser user.

Another example is U.S. Pat. No. 6,049,783 to Segal, which discloses a server-based interactive internet analysis method for sorting, filtering and reporting information by establishing a set of client “criteria”. This type of technology requires server-side support, and again, is not configurable by the web browser user independently of the server operator. The user is limited to the options and choices that the server operator decides to provide, and the information sorted, filtered and reported to the web browser user is limited to that information processed by the server.

In another example, U.S. Pat. No. 6,088,731 to Kiraly discloses a client-side “intelligent assistant” which is triggered by encountering special tags within a document or data received from a web site server. Again, although this invention is primarily implemented as a web browser plug-in on the web browser user's computer, it requires the addition of the special “intelligent agent” tags into the data and documents offered by web servers, and thus is not realizable by a web browser user without cooperation of one or more web server operators.

Another web browser enhancement set forth in U.S. Pat. No. 6,100,890 to Bates provides an automatic “bookmark” function, which automatically creates browser bookmarks based on matching words in a viewed web server page to keywords and the synonym list defined by the web browser user. While this is useful to allow a user to easily return to a previously visited page which matched a set of interest or keywords, it still requires a manual effort and time to re-visit each page to find newly added information on those pages or servers.

As such, there is a need in the art for a system and method which allows a web browser user to specify keywords which represent his or her interests to a web browser computer and software. There further exists a need in the are for these interest keywords or terms may then be applied by the web browser computer and software to web pages and site content to allow the user to quickly and easily find and review information from those sites and servers.

### BRIEF DESCRIPTION OF THE DRAWINGS

The following detailed description when taken in conjunction with the figures presented herein provide a complete disclosure of the invention.

FIG. 1 shows the well-known arrangement between Internet clients or web browser systems, web server systems, and communications networks.

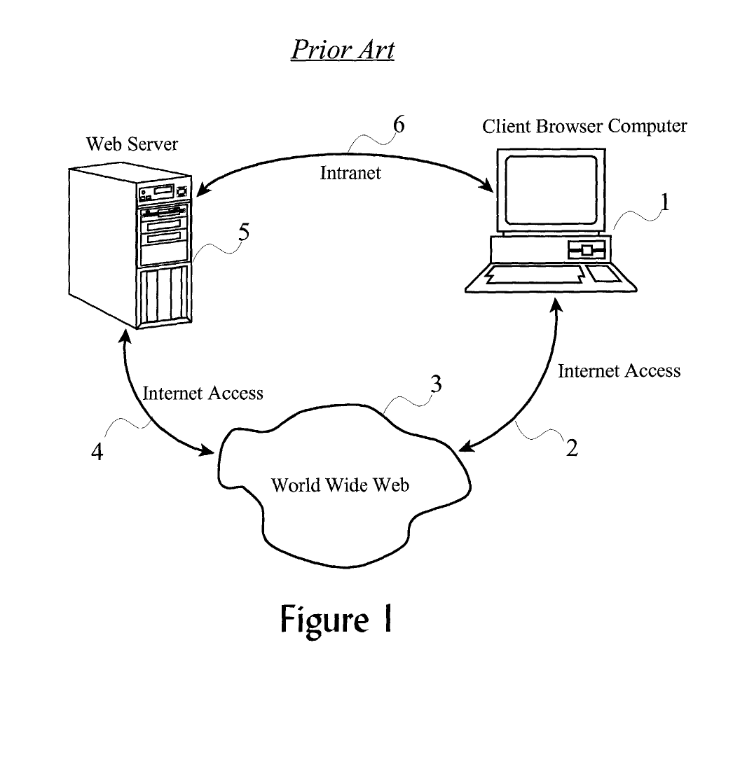

FIG. 2 illustrates the well-known architecture of web browser and web server systems.

FIG. 3 shows the logical flow of the process of the invention.

FIG. 4 discloses the arrangement of the invention.

### SUMMARY OF THE INVENTION

The system and method of the invention permits the browser to determine what keywords may be of interest to the web browser user, such that interest terms could then be fed into other programs for use in assisting the web browser user in finding web content of interest to him or her. The interest terms, such as “photography, baseball, computer, wine, texas” may be as broad or specific as desired by the user. These interest terms may then be made available to and accessed by other web browser functions, such as the web browser application software itself or browser plug-in modules, for such activities as “look ahead browsing”, visual annotation of links leading to interesting information, or visual highlighting of interesting information.

### DETAILED DESCRIPTION OF THE INVENTION

For the purposes of this disclosure, it is assumed that all tasks associated with seeking out and loading web pages are conducted by a web browser application, such as Netscape's Navigator or Microsoft's Explorer. In practice, the invention described herein may be realized in web-browser associated software, which may or may not be part of the browser itself, such as a cooperating stand-alone software application or a web browser plug-in module. As such, it will be recognized by those skilled in the art that the construction of interest term lists, as described herein, can be accomplished by any piece of software, the results of which being made available to other browser-related functions and software.

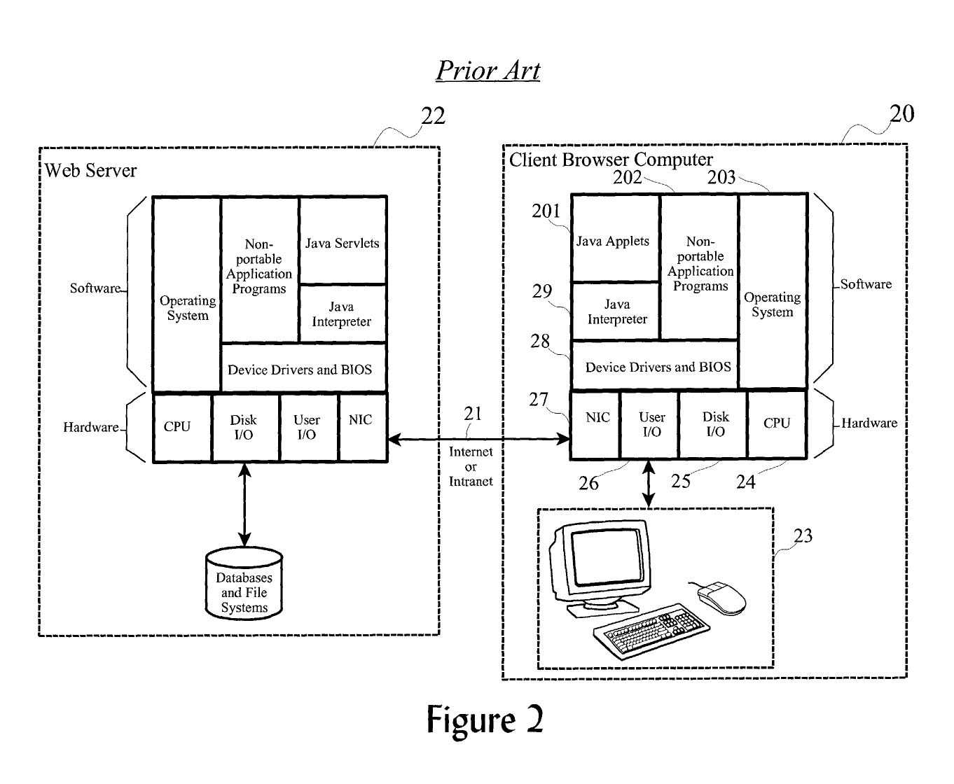

FIG. 2 shows the general hardware and software architectures of typical web servers and web browser computer systems. A web browser computer (20) is communicatively interconnected via an Internet or intranet (21) to a web server computer (22). The web browser system comprises standard user interface devices (23) such as a computer display or monitor, keyboard, and mouse. The web browser computer (20) hardware platform comprises a central processor (“CPU”) (24), disk drives (25), user interface device I/O (26), and network interface card (“NIC”) (27). The NIC may be one of several varieties well known within the art, including a dial-up modem, local area network (“LAN”) card, or cable modem interface. The software executed by the web browser computer (20) may include device drivers and a basic input/output system (“BIOS”) (28), and operating system (203), application programs (202), and an applet interpreter (29) and applets (201). A web browser program, such as Netscape's Navigator, is an application program which can be executed by the CPU (24). This architecture and arrangement with a web server computer is well known within the art.

In the preferred embodiment, a standard web browser application software program is modified to include certain logical and functional enhancements. The functional enhancements utilize several existing capabilities of the existing web browser, such as the abilities to:

(1) interpret received web documents;

(2) cause all or part of a web document to be displayed in the current web browser display window;

(3) display user option icons, drop down lists or other mode control indicators in the web browser display window; and

(4) receive user selections of user option icons, drop down lists and other mode control indicators in the web browser display window;

As the foregoing general arrangement and architecture of a web browser system is well-known in the art, the remaining description of the invention is given relative to steps and functions preferably implemented as a browser plug-in for Netscape's Navigator running under Microsoft's Windows[TM] operating system on an IBM-compatible computer. However, it will be recognized by those skilled in the relevant arts that alternate operating systems, such as UNIX, Linux and Sun Microsystem's Solaris, alternate computer hardware such as IBM's RS6000, Apple's iMac (TM), personal digital assistant's and web-enabled telephones, as well as alternate software embodiments such as Java scripts or compiled programs may be adopted without departing from the spirit and scope of the present invention. In still other embodiments, web server servelets or programs may maintain the interest term list, making that list available to client-side programs and plug-ins upon request.

The invention improves on this original concept and functionality of web browsers in general. It permits the browser to determine what keywords may be of interest to the web browser user, such that interest terms can be utilized by other web browser functions, such as “read-ahead” predictive browsing, automated site content downloading, and visual information highlighters.

According to the preferred embodiment, a user's interest terms may be as broad as general subject headings, e.g. “photography”, “baseball”, “computer”, “wine”, and “Texas”. Alternatively, the interest terms may be very specific, such as “New York Mets,” “Atlanta Braves,” or individual player names.

Ultimately, the browser's ability to perform advanced functions using these interest terms depends on the granularity of the interest term list which drives better searching and highlighting functions, so as processor speeds and storage capacities increase, the number of possible terms and their groupings can be similarly enlarged.

Although this and later examples relate primarily to one particular example subject, namely sports, it will be recognized by those skilled in the art that any imaginable topic could be included to a “master index list” of possible interest terms. This master index might be megabytes long, but analogous lists for user dictionaries and thesauri are already maintained by many applications today. Thus, there is no practical size limitation imposed on this index. The results selected by the user from the “master index” are stored in an “interest term index,” which specifies which terms should be sought out by the browser using advanced predictive methodologies.

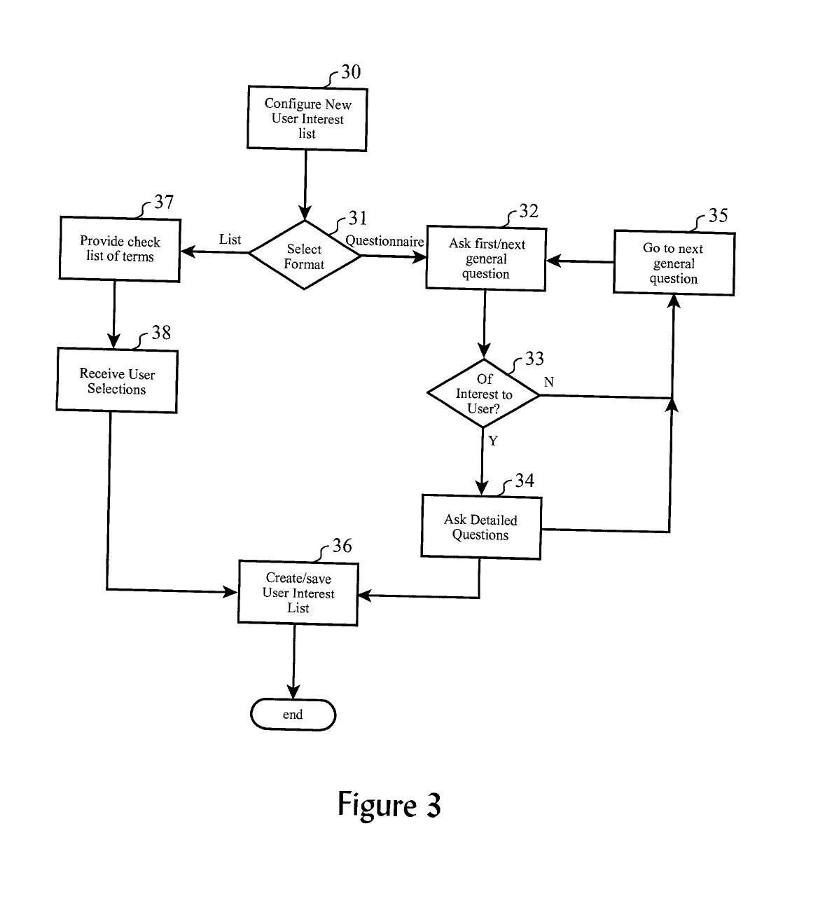

In the preferred embodiment and according to FIG. 3, upon configuration of a new user profile (30), a web browser system prompts the user for his or her interests using an interest configuration plug-in. This may be accomplished in any of several ways, each slightly different, but with identical end results, including an interview or questionnaire format and a master checklist format (31).

According to the interview format, a user-friendly questionnaire may be delivered by the browser to offer a high-level list of questions (32). For example, this questionnaire may ask the user in a conversational manner, “Are you interested in sports?” If the user selects “yes” (33), the browser would then prompt the user to select the sports in which he or she is interested by asking more detailed questions (34), including possibly asking the user to name any specific teams, players, or cities of interest. Ultimately, the browser plug-in queries down multiple levels to obtain more precision of the interest subject. In another example, if the browser plug-in inquired about politics, and the user answers with “no interest,” then the browser would move on to the next general topic (35). In this manner, the user can enter his or her interests to a conversation interface.

In the master checklist format, the interest configuration browser plug-in simply offers an expansive master interest term checklist (37) from which the user can choose. In this embodiment, the browser plug-in presents a comprehensive master list with selection boxes beside each term, from which the end-user may choose whatever topics were of interest to him or her in any desired order (38). The software may elect to generate and present a comprehensive list from the onset, where the user could select any specific term, such as the example shown in TABLE 1.

TABLE 1
Example Portion of Master Interest Term List

_Politics:

_Local
_National
_World

. . .

_Regional Interest:

_United States

_Alabama
_Alaska
_Arkansas
. . .
. . .

_Canada

_Alberta
. . .

_Sports:

_Baseball
_Football
_Martial Arts
. . .

Alternatively, the browser plug-in may present available terms at the highest level with “collapsed” detail or subterms, and the “explode” the available more precise terms when a major topic is selected. For example, the list of TABLE 1 may be shown with collapsed, summary terms as given in TABLE 2, wherein the “+” symbol indicates there are more precise terms available within a category. Responsive to the selection of the term, such as “Sports” from the top-level list, results in the presentation of the next level of precise terms, as shown in TABLE 3.

TABLE 2
Example Top-Level Master Interest Term List

. . .

_Politics [+]
_Regional Interest [+]
_Sports [+]

. . .

TABLE 3
Example Exploded Interest Term Category

. . .

_Politics [+]
_Regional Interest [+]
_Sports [−]

_Baseball [+]
_Pro Football [+]
_College Football [+]
_Pro Basketball [+]
_Men's College Basketball [+]
_Women's College Basketball [+]
_Motor Sports [+]
. . .

. . .

As seen in TABLE 3, each list may comprise multiple sub-lists, and each item in those sub-lists may lead to further sub-lists, ad infinitum. Through use of such a hierarchical options list, the user may select an entire category by selecting the top term of a category list or sub-list, or the user may explode the sub-lists and select only the terms of interest in order to create a more precise selection.

These presented interest terms represent the contents of the “master interest index.” The resultant list, as selected by the user, is constructed and saved (36) as the “interest term index” relevant to the particular web browser user's tastes.

An example user's interest term list is provided in TABLE 4, using a comma-separated variable (“CSV”) format wherein a colon “:” is defined to indicate a general category for which subcategories are specified. If no colon follows a category or term, it is assumed that all subcategories and terms available under that category are of interest.

TABLE 4
Example User's Interest Term List File

Politics <CR>
Sports: Baseball, Professional Basketball, Motor Sports <CR>
<EOF>

The user's interest term list is preferably directly user-editable such if a user wishes to delete an interest term which may have been added earlier, he or she may do so easily with a common text file editor or database program. Similarly, if a user wishes to add an interest term at a later time, he or she should have the option of re-invoking the menus or directly editing a file to do so.

The created user's interest term list may then be used as discussed previously, such as for predictive browsing methodologies, automated downloading of web site content, etc., by other system programs, plug-ins and software.

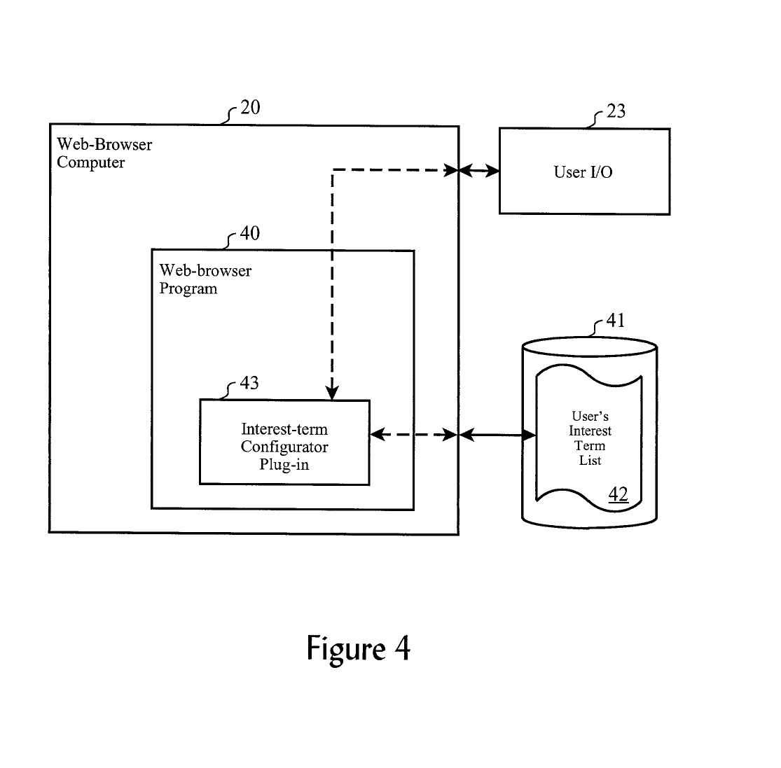

Turning to FIG. 4, the realized structure of the system is shown. The interest-term configurator plug-in (43) runs within the environment of the web browser program (40) on the web browser computer (20), using the web browser computer's user I/O (23) facilities to present the master list and receive the user's selections or answers. Preferably, the created user's interest term list (42) is stored (41) in a simple text file on the hard drive or in persistent memory of the web browser system (20). Alternatively, the user's interest term list (42) may be stored (41) in an accessible database on a web or network server where it is accessible by the web browser system (20).

By incorporating the invention into a web browsing system or product, a more intelligent means of determining available information which matches a user's interests is enabled. The application of such keywords and interest terms by web browser system components will undoubtedly improve the performance of the software, and result in smarter, more focused web interfaces, and higher end-user satisfaction for software exploiting the art described here.

While specific examples and details related to a preferred embodiment have been set forth herein, it will be recognized by those skilled in the art that various alternatives and engineering choices made by made without departing from the spirit and scope of the present invention, including but not limited to realization of the method as an application program, portable language script, server-side program or script, or browser enhancement; use of a different web browser computer such as a web-enabled telephone, Internet appliance, or personal digital assistant; and use of an alternative operating system such as Windows[TM] CE. Therefor, the scope of the present invention should only be determined by the following claims.

What is claimed is:

1. A method for creating a list of interest terms for a user of a web browser system, said web browser system having a user display, a user input device, and a persistent storage device, said method comprising the steps of:
providing a user dialog on said user display for presenting a plurality of available interest terms from an interest term master list;
receiving at least one user selection of an interest term; and
creating a user interest term list containing selected interest terms.

2. The method as set forth in claim 1 wherein said step of providing a user dialog comprises providing a series of questions regarding available interest terms, and wherein said step of receiving at least one user selection comprises receiving an affirmative answer to at least one provided question.

3. The method as set forth in claim 1 wherein said step of providing a user dialog comprises providing a master checklist of available interest terms, and wherein said step of receiving at least one user selection comprises receiving user selections of at least available interest term on said master checklist.

4. The method as set forth in claim 1 wherein said step of creating a user interest term list comprises creating a text file containing selected interest terms.

5. The method as set forth in claim 1 wherein said step of creating a user interest term list comprises creating a record in a database.

6. The method as set forth in claim 1 wherein said step of creating a user interest term list comprises storing a user interest term list in persistent memory of said web browser system.

7. The method as set forth in claim 1 wherein said step of creating a user interest term list comprises storing a user interest term list in persistent memory of said a server system communicable and accessible by said web browser system.

8. A computer-readable medium having stored thereon program code or creating a list of interest terms for a user of a web browser system, said web browser system having a user display, a user input device, and a persistent storage device, said program code when executed by a web browser system causing the web browser system to perform the steps of:
providing a user dialog on said user display for presenting a plurality of available interest terms from an interest term master list;
receiving at least one user selection of an interest term; and
creating a user interest term list containing selected interest terms.

9. The computer-readable medium as set forth in claim 8 wherein program code for performing the step of providing a user dialog comprises program code for providing a series of questions regarding available interest terms, and wherein said program code for performing the step of receiving at least one user selection comprises program code for receiving an affirmative answer to at least one provided question.

10. The computer-readable medium as set forth in claim 8 wherein program code for performing the step of providing a user dialog comprises program code for providing a master checklist of available interest terms, and wherein program code for performing the step of receiving at least one user selection comprises program code for receiving user selections of at least available interest term on said master checklist.

11. The computer-readable medium as set forth in claim 8 wherein program code for performing the step of creating a user interest term list comprises program code for creating a text file containing selected interest terms.

12. The computer-readable medium as set forth in claim 8 wherein program code for performing the step of creating a user interest term list comprises program code for creating a record in a database.

13. The computer-readable medium as set forth in claim 8 wherein program code for performing the step of creating a user interest term list comprises program code for storing a user interest term list in persistent memory of said web browser system.

14. The computer-readable medium as set forth in claim 8 wherein program code for performing the step of creating a user interest term list comprises program code for storing a user interest term list in persistent memory of said a server system communicable and accessible by said web browser system.

15. An enhanced web browser system with user-defined interest terms for a user comprising:
a processor for executing program code;
a user display for presenting information to a user;
a user input device for receiving user input;
a persistent storage device for storing data and information;
and a user interest configurator program executable by said processor for causing the web browser system to provide a user dialog on said user display presenting a plurality of available interest terms from an interest term master list, receive at least one user selection of an interest term, and create a user interest term list containing selected interest terms.

16. The enhanced web browser system as set forth in claim 15 wherein said program is adapted to provide a series of questions regarding available interest terms and to receive at least one user selection as an affirmative answer to at least one provided question.

17. The enhanced web browser system as set forth in claim 15 wherein said program is adapted to provide a master checklist of available interest terms, and to receive at least one user selection interest terms on said master checklist.

18. The enhanced web browser system as set forth in claim 15 wherein said program is adapted to create flat text file containing said user interest term list.

19. The enhanced web browser system as set forth in claim 15 wherein said program is adapted to create a record in a database containing said user interest term list.

20. The enhanced web browser system as set forth in claim 15 wherein said program is adapted to store said user interest term list in persistent memory of said web browser system.

21. The enhanced web browser system as set forth in claim 15 wherein said program is adapted to store said user interest term list in persistent memory of said a server system communicable and accessible by said web browser system.
